(19) United States
(12) Patent Application Publication
(10) Pub. No.: US 2001/0046860 A1
(43) Pub. Date: Nov. 29, 2001

(54) Call originating service method in a public and private common mobile communication system and apparatus

(76) Inventor: Dong-Youl Lee, Suwon-Shi (KR)

Correspondence Address: Robert E. Bushnell, Suite 300, 1522 K Street, N.W., Washington, DC, 20005-1202, US

(21) Appl. No.: 09/805,929

(22) Filed: Mar. 15, 2001

(30) Foreign Application Priority Data
May 24, 2000 (KR) P2000-28170

(51) Int. Cl. H04M 3/42; H04Q 7/20

(52) U.S. Cl. 455/426; 455/445; 455/462; 455/465

(57) ABSTRACT

A public/private common mobile communication system provides a call originating service method. Upon receipt of an origination call message from a mobile station (MS) through a BTS (Base station Transceiver Subsystem) which provides both public and private mobile communication services, it is determined whether the call origination message is for the public mobile communication service or the private mobile communication service. The call origination message is transmitted to either a public mobile communication network or a private mobile communication network based on the determination results.

### CLAIM OF PRIORITY

This application makes reference to, incorporates the same herein, and claims all benefits accruing under 35 U.S.C. §119 from my application Call Originating Service Method of Public and Private Common Mobile Communication System and Apparatus therefor filed with the Korean Industrial Property Office on May 24, 2000 and there duly assigned Serial No. 2000-28170.

### BACKGROUND OF THE INVENTION

1. Field of the Invention

The present invention relates generally to a mobile communication system, and in particular, to a call originating service method in a system which provides both public and private mobile communication services, and an apparatus therefor.

2. Description of the Related Art

In general, a mobile communication network can be divided into a public mobile communication network and a private (or in-building) mobile communication network, and the two networks cannot interact with each other. That is, the mobile communication system is so designed as to optionally provide either the public mobile communication service or the private mobile communication service, so that the mobile terminal subscriber registered in a specific network can be provided with the service only in the registered network. Therefore, a mobile terminal subscriber registered in the public mobile communication network cannot be provided with the private mobile communication service, and on the contrary, a mobile terminal subscriber registered in the private mobile communication network cannot be provided with the public mobile communication service. Accordingly, there has been a demand for a method for enabling the mobile terminal subscriber to be provided with both the public and private mobile communication services using one mobile terminal. Further, for the case where a system is so implemented as to provide both the public and private mobile communication services, a method is required which can determine whether an outgoing call (or originating call) is originated in the public mobile communication network or in the private mobile communication network, and then provide the corresponding service according to the determination.

### SUMMARY OF THE INVENTION

It is, therefore, an object of the present invention to provide a call originating service method in a system which can provide both the public and private mobile communication services, and an apparatus therefor.

It is another object of the present invention to provide an apparatus and method for determining whether an originating call generated by a mobile terminal of a system which can provide both the public and private mobile communication services is originated in a public mobile communication network or in a private mobile communication network.

It is further another object of the present invention to provide an apparatus and method for determining whether an originating call generated by a mobile terminal of a system which can provide both the public and private mobile communication services is originated in a public mobile communication network or in a private mobile communication network, and then providing a corresponding service according to the determination.

To achieve the above and other objects, there is provided a call originating service method in a public/private common mobile communication system. Upon receipt of an origination call message from a mobile station (MS) through a BTS (Base station Transceiver Subsystem) which provides both public and private mobile communication services, it is determined whether the call origination message is for the public mobile communication service or the private mobile communication service. The call origination message is transmitted to either a public mobile communication network or a private mobile communication network based on the determination results.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a network structure diagram for explaining a concept of a public/private mobile communication service according to an embodiment of the present invention;

FIG. 2 is a detailed diagram illustrating the public/private communication service unit (12) and the pBTS (8ₖ) of FIG. 1;

FIG. 3 is a detailed block diagram of FIG. 2;

FIG. 4 is a software block diagram of the call manager (50) of FIG. 3;

FIG. 5 is a diagram illustrating private mobile communication service registered-subscriber information stored in the database (76) of the pVLR (64) shown in FIG. 4;

FIG. 6 is a flow chart for explaining a call originating service according to an embodiment of the present invention; and

FIG. 7 is a diagram illustrating a packet message structure.

### DETAILED DESCRIPTION OF THE INVENTION

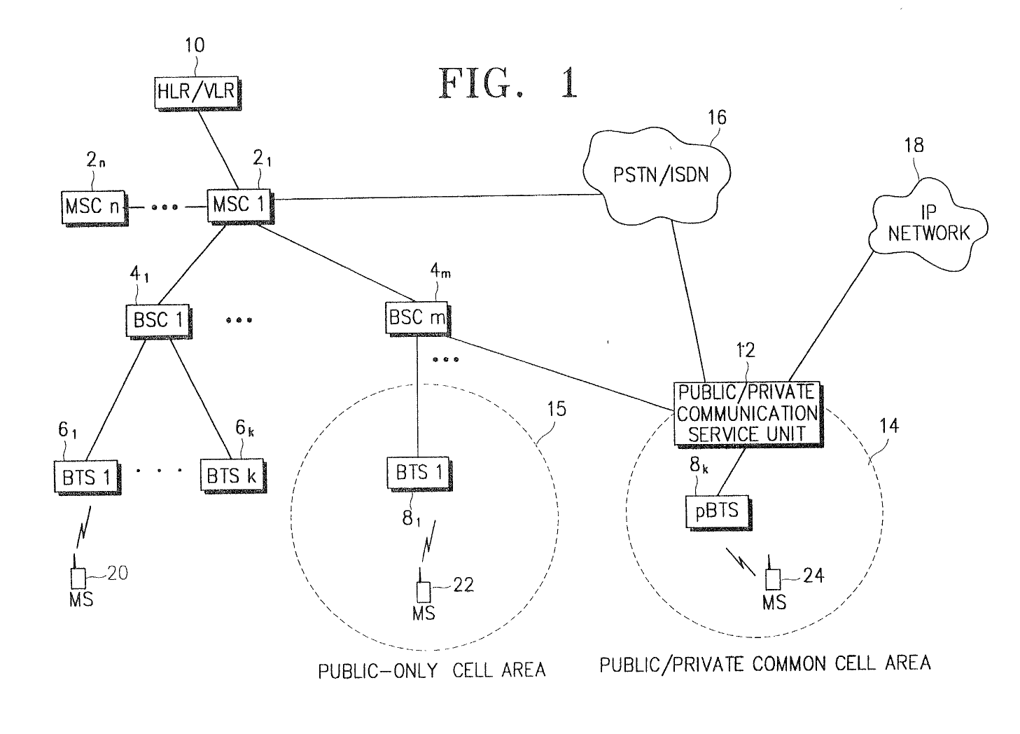

FIG. 1 illustrates a network structure for explaining a concept of a public/private mobile communication service according to an embodiment of the present invention. In order to provide both the public and private mobile communication services, an embodiment of the present invention, as shown in FIG. 1, includes a public/private common cell area 14 which is a public/private common communication service area, and a public/private communication service unit 12. Preferably, the public/private common cell 14 is set to provide a convenience of the communication service to a specific group. For example, when a certain company uses (occupies) one building, the area belonging to the building can be defined as the public/private common cell 14. The public/private common cell 14 is preferably defined by mutual agreement with the public mobile communication service provider. This is to have a private BTS (Base station Transceiver Subsystem) 8ₖ in the public/private common cell 14 be recognized as a public BTS from the viewpoint of the public mobile communication system. In the following description, the private BTS 8ₖ will be referred to as ApBTS@, in order to distinguish the private BTS 8ₖ in the public/private common cell 14 from the BTSs belonging to the public mobile communication system, i.e., the BTSs 6₁-6ₖ and 8₁ shown in FIG. 1. The pBTS 8ₖ, together with a mobile station (MS) 24 in the public/private common cell 14, forms a radio communication path, performs a function of managing the radio resources, and is connected to a BSC (Base Station Controller) 4ₘ of the public mobile communication system through the public/private communication service unit 12. The public/private communication service unit 12 is connected to BSC 4ₘ, PSTN/ISDN (Public Switched Telephone Network/Integrated Services Digital Network) 16, and IP (Internet Protocol) network 18. The public/private communication service unit 12 optionally provides the public mobile communication service and the private mobile communication service to the MSs (e.g., the MS 24) in the public/private common cell 14. If the MS 24 is registered in the public/private communication service unit 12 to be provided with the private mobile communication service, the MS 24 can be provided with not only the public mobile communication service but also the private mobile communication service. However, if the MS 24 is not registered in the public/private communication service unit 12 for the private mobile communication service, the MS 24 can be provided with only the public mobile communication service. In addition, the public/private communication service unit 12 also performs a wire communication service with the PSTN/ISDN 16 and the IP network 18.

Meanwhile, the public mobile communication network is commonly called a Apublic land mobile network (PLMN)@. As illustrated in FIG. 1, the public mobile communication system includes a plurality of mobile switching centers (MSCs) 2₁-2ₙ, a plurality of base station controllers (BSCs) 4₁-4ₘ, a plurality of BTSs 6₁-6ₖ and 8₁-8ₖ, a plurality of mobile stations (MSs) 20, 22 and 24, and a HLR/VLR (Home Location Register/Visitor Location Register) 10. Each of the MSCs 2₁-2ₙ is connected to its associated BSCs 4₁-4ₘ, and each of the BSCs 4₁-4ₘ is connected to its associated BTSs 6₁-6ₖ and 8₁-8ₖ. In particular, the pBTS 8ₖ is one of the BTSs 8₁-8ₖ connected to the BSC 4ₘof the public mobile communication system according to an embodiment of the present invention. The MSCs 2₁-2ₙ each control the connection between the BSCs 4₁-4ₘ connected thereto and the PSTN/ISDN 16 or another MSC in the public mobile communication network. The BSCs 4₁-4ₘ each perform the radio link control and handoff functions, and the BTSs 6₁-6ₖ and 8₁-8ₖ perform the functions of forming the radio communication paths to the MSs 20, 22 and 24 belonging to their communication service area, i.e., their cell area and managing the radio resources. In the HLR/VR 10, the HLR has a subscriber location registration function and a database function for storing the subscriber information, and the VLR has a database function for temporarily storing information about the MS existing in the cell managed by a corresponding one of the MSCs 2₁-2ₙ . If the MS moves to a cell managed by another MSC, the corresponding information stored in the VLR is deleted. In the following description, a communication service area for the BTSs 6₁-6ₖ and 8₁ of the public mobile communication system will be called a Apublic-only cell area@, in order to distinguish it from the public/private common cell area 14. For example, in FIG. 1, a communication service area for the BTS 8₁ among the BTSs 6₁-6ₖ and 8₁ of the public mobile communication system is defined as a public-only cell area 15. Commonly, the public-only cell area 15 is much wider than the public/private common cell area 14, which is set to provide a convenience of the communication service to a specific group.

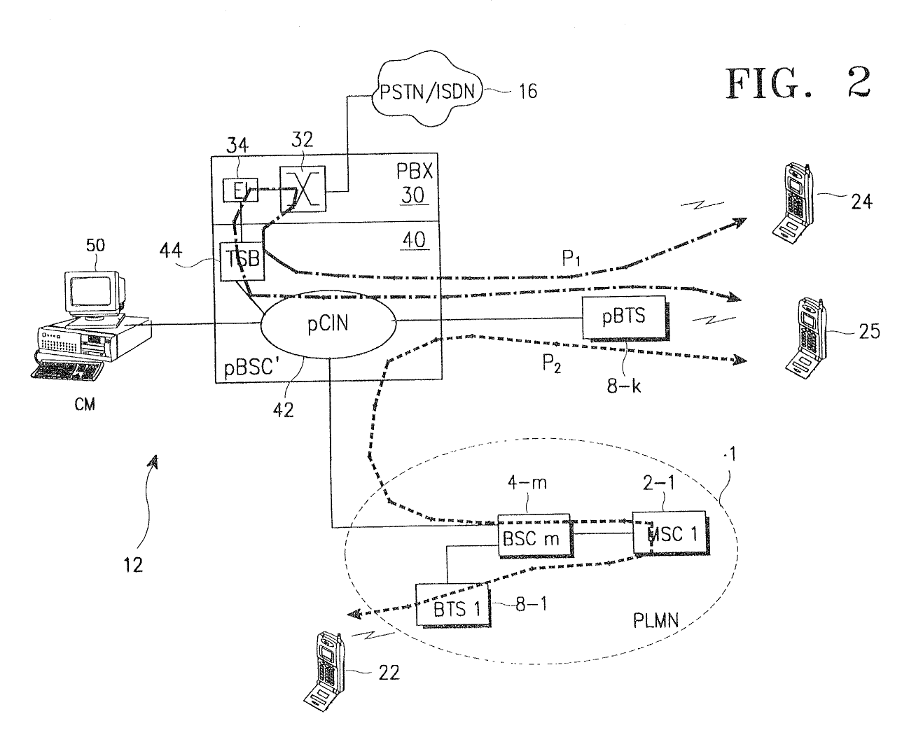

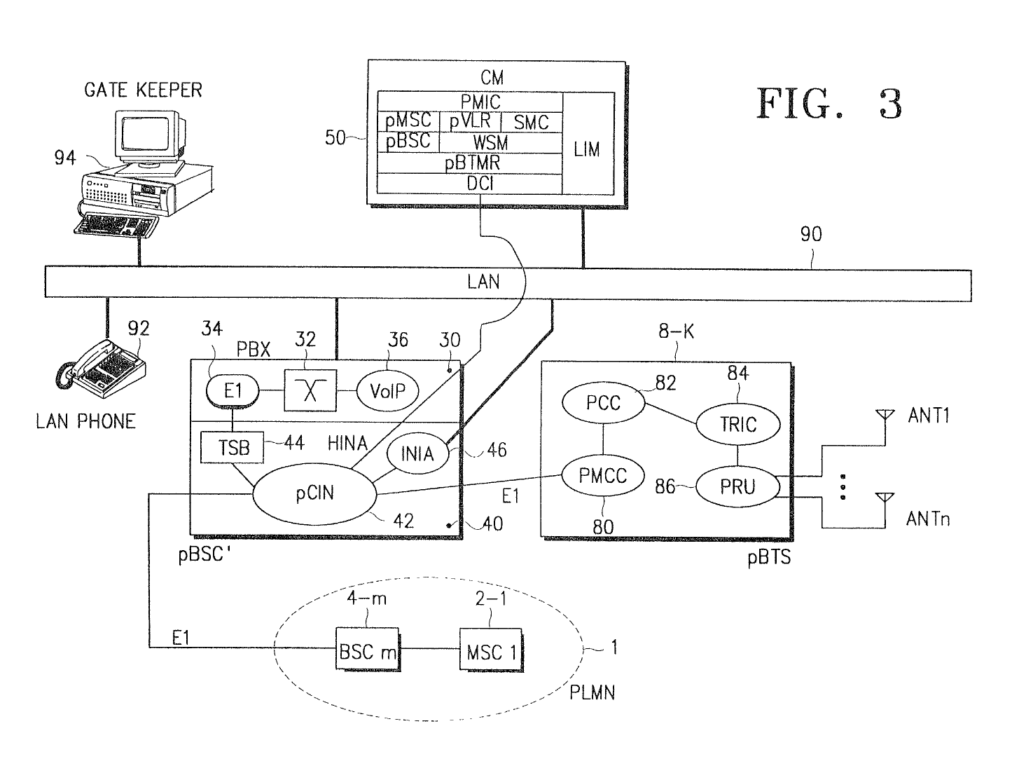

FIG. 2 illustrates a detailed structure of the public/private communication service unit 12 and the pBTS 8ₖ shown in FIG. 1, and FIG. 3 is a detailed block diagram of FIG. 2. In particular, FIG. 2 is a diagram for showing communication paths formed when the public and private mobile communication services are provided according to an embodiment of the present invention.

Referring first to FIG. 2, the public/private communication service unit 12 of FIG. 1 is comprised of a private branched exchange (PBX) 30, a private BSC (pBSC′) 40, and a call manager (CM) 50. The PBX 30 includes a switch 32 and an E1 interface 34, and the pBSC′ 40 includes a pCIN (private Communication Interconnection Network) 42 and a TSB (Transcoder & Selector Bank) 44. It is to be noted that FIG. 2 shows only the elements of the PBX 30 and the pBSC′ 40, which are required in explaining the communication paths formed when the public and private mobile communication services are provided. It will be assumed herein that the MSs 24 and 25 of FIG. 2 are both located in the public/private common cell area 14 and registered in the public/private communication service unit 12 to be provided with the private mobile communication service, whereas the MS 22 is located in the public-only cell area 15. On the above assumptions, a communication path (i.e., traffic channel) P1, which is formed through the MS 24, the pBTS 8ₖ, the pCIN 42, the TSB 44, the E1 interface 34, the switch 32, the TSB 44, the pCIN42, the pBTS 8ₖ and the MS 25 or formed in the opposite direction, is a communication path formed to provide the private mobile communication service. Further, a communication path (i.e., traffic channel) P2, which is performed through the MS 25, the pBTS 8ₖ, the pCIN 42 in the pBSC′ 40, and the BSC 4ₘ, the MSC 2₁, the BSC 4ₘ, the BTS 8₁ and the MS 22 of the PLMN (Public Land Mobile Network) or formed in the opposite direction, is a communication path formed to provide the public mobile communication service. Forming such communication paths for the public and private mobile communication services is performed under the control of the call manager 50 which is a main controller of the public/private communication service unit 12.

The public/private communication service unit 12 according to an embodiment of the present invention provides a wire service, an IP terminal service, and a public/private mobile communication service. The wire service is performed by the PBX 30 of FIGS. 2 and 3, the inter-IP terminal service is performed by a gate keeper 94 of FIG. 3, and the public/private mobile communication service, i.e., a wireless call service is performed by the call manager 50 of FIGS. 2 and 3.

In FIG. 3, the PBX 30, an INIA (IP Network Interface board Assembly module) 46 of the pBSC′ 40, and a LIM (LAN Interface Module) of the call manager 50 are connected to a LAN (Local Area Network) 90. The gate keeper 94 is also connected to the LAN 90, and the IP terminals such as a LAN phone 92, a web phone (not shown) and a PC (Personal Computer; not shown) are also connected to the LAN 90.

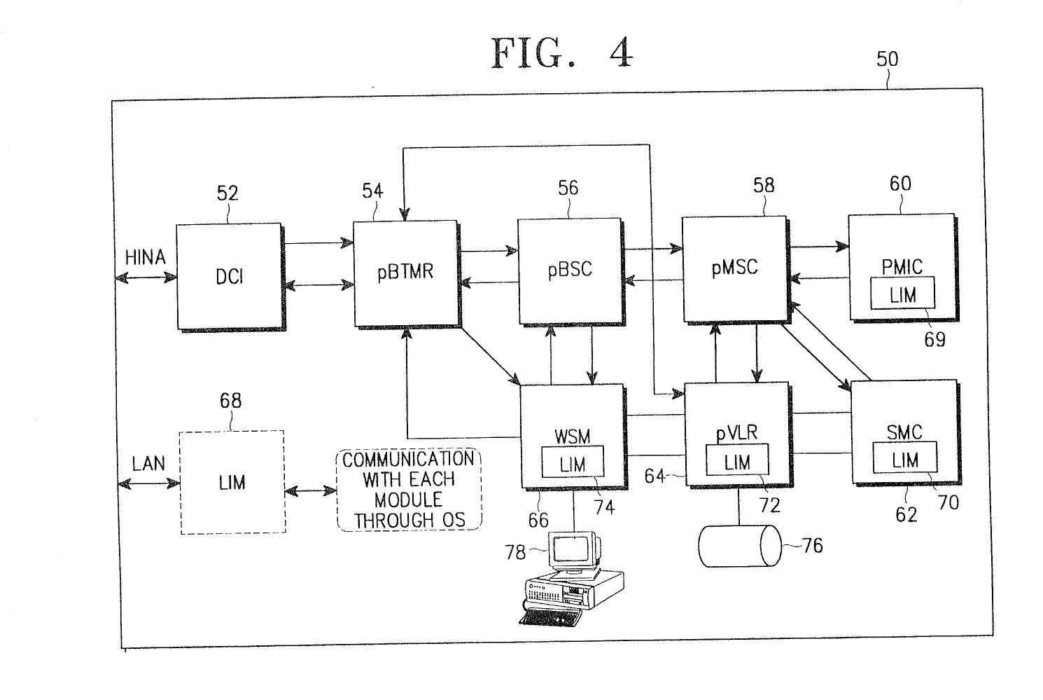

As shown in FIGS. 2 and 3, the pBSC′ 40 according to an embodiment of the present invention performs the corresponding functions of the BSC in the public mobile communication system, i.e., the radio link control and handoff functions. A main controller of the pBSC′ 40, which will be described later with reference to FIG. 4, is included in the call manager 50 as a software block (which is indicated by a pBSC 56 in the call manager 50 of FIG. 4). The pBSC′ 40 includes the pCIN (private Communication Interconnection Network) 42. The pCIN 42 provides a communication path to the call manager 50, a communication path to the BSC 4ₘ of the PLMN 1, a communication path to the pBTS 8ₖ, and a data path between respective blocks in the pBSC′ 40. That is, the pCIN 42 analyzes a message type and origination addresses and termination addresses included in the received message, and then transmits the analyzed information to the corresponding device or processor. The connection between the pCIN 42 and the BSC 4ₘ of the PLMN 1 and the connection between the pCIN 42 and the pBTS 8ₖ are implemented by the E1 line. The TSB (Transcoder & Selector Bank) 44 connected to the pCIN 42 in the pBSC′ 40 is used to provide the private mobile communication subscriber with the wireless communication service. The TSB 44 has a function for traffic data interfacing between the PBX 30 and the pBSC′ 40. More specifically, the TSB 44 performs a 2.048 Mbps/1.544 Mbps non-multiple transmission channel interfacing function, a vocoder function for voice coding and decoding (e.g., PCM (Pulse Code Modulation):QCELP (Qualcomm Code Excited Linear Predictive coding)), a soft handoff control and voice selecting function, and a power control function. The INIA 46 connected to the pCIN 42 in the pBSC′ 40 controls the wireless in-building data service according to an embodiment of the present invention. The INIA 46 has a function of transmitting to the LAN 90 the packet data received from the MS of the public/private common cell area 14, which uses a PPP (Point-to-Point Protocol) server and a TCP/IP (Transmission Control Protocol/Internet Protocol).

A VoIP (Voice over Internet Protocol) block 36, which is located in the PBX 30 of FIG. 3 and connected between the switch 32 and the LAN 90, services the VoIP function when the wire terminal (not shown) connected to the PBX 30 is interlinked with the IP terminal such as the LAN phone 92 by the switch 32.

The call manager 50 of FIG. 3 is connected to the pBSC′ 40 and the LAN 90. The structure and operation of the call manager 50 will be described below in detail. The call manager 50 has the function of controlling a wireless call for the public and private mobile communication services. Here, a call service for the MS of the public mobile communication network is such controlled that a message should be bypassed to the public MSC. In addition, the call manager 50 has a function of managing and maintaining the radio resources. However, resource management for the pBTS 8ₖ is controlled by the public MSC 2₁ and the call manager 50 only consults the resource management. Further, the call manger 50 has a function of loading a program for a processor for controlling the pBSC resource and loading PLD (Program Loaded Data). However, program loading for the pBTS 8ₖ is managed by a public BSM (Base Station Manager; not shown). In addition, the call manager 50 controls a wire/wireless complex function. Moreover, the call manager 50 supports a wireless in-company short message service (SMS) function, and has an SMS function for that purpose. In addition, the call manager 50 supports a registration function for a private mobile communication network subscriber and a function setting function, and has a VLR management function for roaming the MS registered in the private mobile communication network. In order to perform such functions, the call manager 50, as shown in FIG. 4, includes such software blocks as a DCI (Data Communication Interface) 52, a pBTMR (pBTS Message Router) 54, a pBSC (private BSC) 56, a pMSC (private MSC) 58, a PMIC (PBX Mobile Interface Controller) 60, an SMC (Short Message service Controller) 62, a pVLR (private VLR) 64, a WSM (Wireless System Manager) 66 and a LIM (LAN Interface Module) 68. In FIG. 4, the DCI 52 is an interface module for interfacing communication between the pCIN 42 in the pBSC′ 40 and the call manager 50, and manages interprocess communication (IPC) through HINA (High Capability IPC Processor Assembly). The pBTMR 54 is a module for managing path designation over every message to be processed in the pBTS 8ₖ. More specifically, the pBTMR 54 designates a signaling message path for public/private call origination and termination services of the MS by consulting a router table therein, and designates a message path for a maintenance service of the pBTS 8ₖ. In addition, the pBTMR 54 communicates with the pVLR 64. The pBSC 56 is a main controller of the pBSC′ 40 shown in FIG. 2 and controls the pBTS 8ₖ′ In supporting both the public mobile communication service and the private mobile communication service, the pMSC 58 is interposed between the pBSC 56 and the PMIC 60 to perform a function corresponding to the function performed by the MSC of the existing public mobile communication network. In addition, the pMSC 58 fundamentally processes a subscriber=s call, analyzes additional services and performs interfacing for interworking with the PBX 30. More specifically, the pMSC 58 analyzes the subscriber=s service request, works out a fundamental strategy as to whether to process the requested service as the existing public mobile communication network service or the private mobile communication network service, and defines the corresponding procedure. For interfacing with the pBSC 56, the pMSC 58 follows the procedure of the existing public mobile communication network, and for mutual interfacing, uses the IPC (Inter-Processor Communication). The PMIC 60 is a module for controlling a wire/wireless complex function. The PMIC 60 is a module, which exists in the public/private common cell area 14, and controls a call among the MSs (e.g., MS 24 shown in FIGS. 1 and 2) registered for the private mobile communication service, the MS 25 shown in FIG. 2, and the wire terminals connected to the PBX 30. Unlike the existing public MSC, the pMSC 58 cannot perform the switching function. Since the pMSC 58 is a software block, it does not have the switch as in the public MSC. Therefore, when providing the private mobile communication service, the public/private communication service unit 12 according to the present invention uses the switch 32 in the PBX 30. In the embodiment of the present invention, a module of the PMIC 60 exists between the pMSC 58 and the PBX 30. The PMIC 60 generates a command for controlling the switch 32 in the PBX 30 in response to a switch control request, and applies the generated command to a controller (not shown) of the PBX 30. The controller of the PBX 30 then performs a switch control operation according to the command. The SMC 62 is a module for managing a short message service (SMS) control function and an SMS web server function. The pVLR 64 is a module for managing the private mobile communication service-registered subscriber information, the private mobile communication subscriber=s location registration information, and various functional service information. To the pVLR 64 is connected a database 76 for storing the above information. The WSM 66 maintains and manages the whole mobile communication service function provided from the public/private communication service unit 12. To the WSM 66 is connected an operator console 78 for interfacing with the operator. The LIM 68, a module for managing communication with the LAN 90, is comprised of a LIM 69 in the PMIC 60, a LIM 70 in the SMC 62, a LIM 72 in the pVLR 64, and a LIM 74 in the WSM 66. The LIMs 69, 70, 72 and 74 manage communication with their associated modules of the PMIC 60, the SMC 62, the pVLR 64 and the WSM 66, respectively, through the LAN 90 using an operating system (OS).

As described above, in the embodiment of the present invention, the programs (WSM,bVLR, SMC, SMS web server, and data service manager), which were conventionally performed by several devices, are performed by one device of the call manager 50. Accordingly, it is possible to increase the system processing efficiency by changing the complicated interfacing to inter-disk message communication under one operation system (OS). The call manager 50 with the software blocks included therein can use the commercial computer as a platform.

Turning back to FIG. 3, the pBTS 8ₖ includes a PMCC (PBTS Main Controller Card) 80, a PCC (pBTS Channel Card) 82, a TRIC (Transmit & Receive Interface Card) 84, and a PRU (′)BTS Radio Unit) 86. The pBTS 8ₖ has the structure and operation similar to those of the BTS in the common public mobile communication system, so that the detailed description will be avoided for simplicity. In the pBTS 8ₖ, the PMCC 80, a block for controlling the overall operation of the pBTS 8ₖ, processes a call setup and system performance-related signaling message, manages the hardware and software configuration, and allocates necessary resources. The PCC 82 processes a baseband signal defined by the radio specification. The TRIC 84 manages transmit/receive interfacing between the PRU 86 and the PCC 82. The PRU 86, a radio unit, is connected to a plurality of antennas ANTI-ANTn.

The public/private communication service unit 12 according to an embodiment of the present invention provides the wire service, the IP terminal service, and the public/private mobile communication service. Now, a detailed description will be made of the public/private mobile communication service performed by the public/private communication service unit 12.

The public/private communication service unit 12 provides the MSs registered in the call manager 50 with the complex function service associated with the wire functions as well as the wireless functions. The wireless function-related services include a call origination service, a call termination service, a call transfer service, a call forwarding service, a wireless in-building data service, a wireless in-building SMS service, etc. Further, the wire/wireless complex function service includes, for example, a function of simultaneously generating a termination ring at both the wire terminal and the MS, when a call terminates at the wire terminal.

Providing both the public mobile communication service and the private mobile communication service is performed by analyzing every message being applied to the public/private communication service unit 12, transparently transmitting the messages for the public mobile communication network to the public BSC, and routing the messages for the private mobile communication network to a module in the call manager 50. Such a path designation function is performed by a module of the pBTMR 54 in the call manager 50. When such events as call origination, call termination, location registration and SMS service events occur, the pBTMR 54 analyzes the corresponding event message and then designates a path according to the analysis. The pBTMR 54 includes a router table in which designated path information is mapped in association with the respective events, and upon receipt of a message, transmits the received message to the corresponding device and module by consulting the router table.

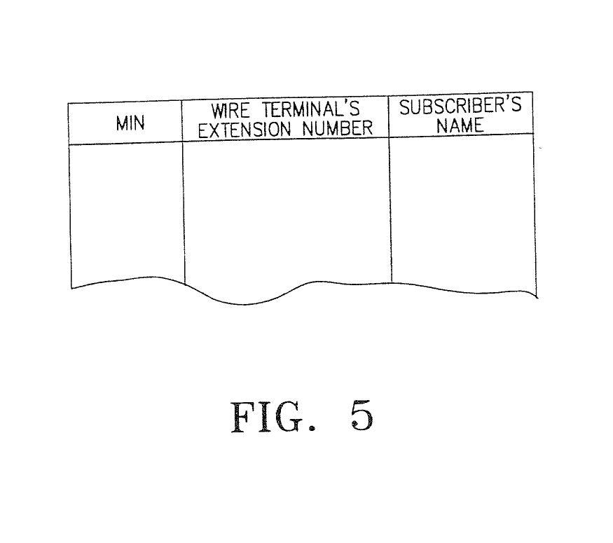

First, a description will be made of an operation in which the MS staying in the public/private common cell area 14 registers the private mobile communication service to be provided with the private mobile communication service. When the operator requests registration of the private mobile communication service using the operator console 78 shown in FIG. 4, the WSM 66 displays a service registration input screen on the monitor of the operator consol 78. The WSM 66 displays a screen for inputting the private mobile communication service-registered subscriber information such as MIN (Mobile IdentificationNumber) of the MS, the wire terminal=s extension number and subscriber=s name, shown in FIG. 5. When the operator inputs the corresponding information, the WSM 66 stores the input information in the database 76 of the pVLR 64 as shown in FIG. 5.

The public/private communication service unit 12, when the MS user staying in the public/private common cell area 14 originates a call, should determine whether the MS user desires to be provided with the private mobile communication service or the public mobile communication service. To this end, when the user desires to be provided with the private mobile communication service, preset identification information for service identification is added to the MS user=s originating (or calling) number, and the public/private communication service unit 12 determines whether the origination call requests the public mobile communication service or the private mobile communication service. In the embodiment of the present invention, the identification information corresponds to a value of #-key on the keypad of the MS terminal, and the identification information by the #-key is to be added at the head of the originating number.

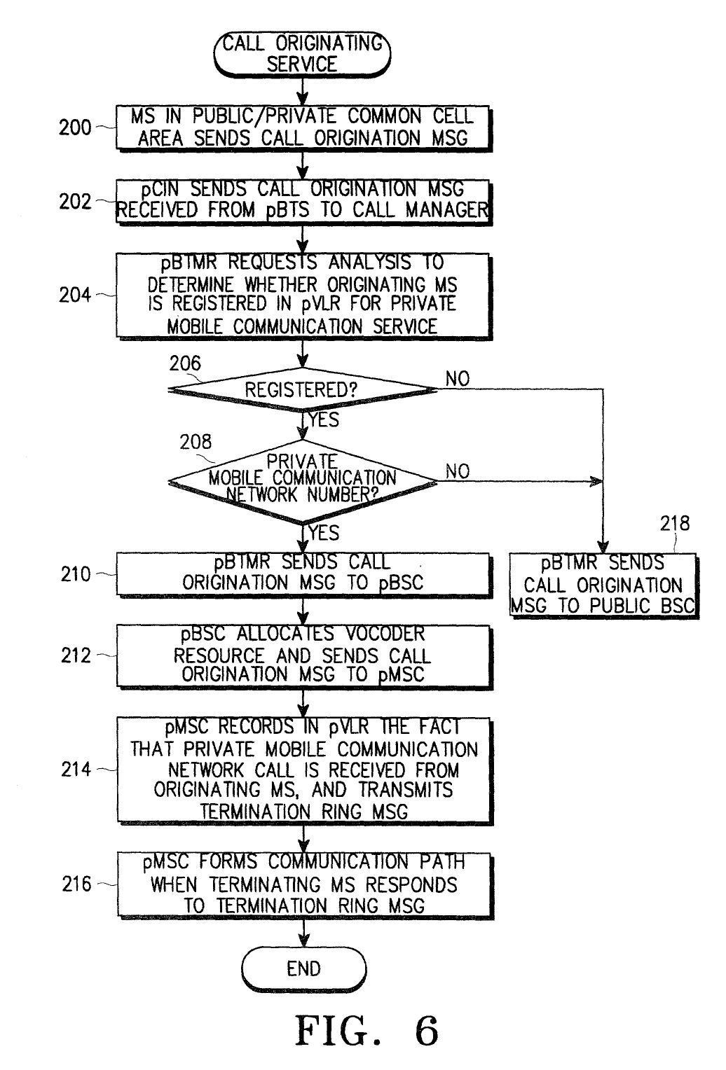

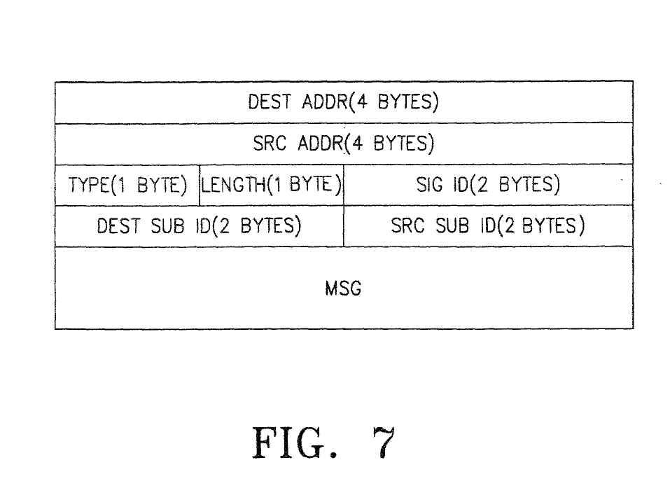

Next, the call originating service according to an embodiment of the present invention will be described in detail with reference to FIGS. 1 to 7. FIG. 6 is a diagram for explaining the call originating service according to an embodiment of the present invention, and FIG. 7 illustrates a packet message structure. In FIG. 7, a DEST_ADDR field is a field where a destination address is recorded, and a SRC_ADDR field is a field where a source address is recorded. Further, a TYPE field is a field for recording the message type which indicates whether the message is a control message or a traffic message. A LENGTH field is a field for recording length information of the message MSG, and a SIG_ID field is a field where signaling type (call origination or call termination) information is recorded. A DEST_SUB_ID field is a field for recording a designated processor=s ID out of the processors belonging to the other party=s device. A SRC_SUB_ID field is a field for recording a designated processor=s ID out of the processors belonging to the calling party=s device. A MSG field is a field where a message is recorded.

If the MS user now staying in the public/private common cell area 14 inputs (or presses) an originating number (i.e., a phone number of the called subscriber) using the keypad of the MS and then inputs a SEND key, the MS transmits a call origination message to the pCIN 42 in the pBSC′ 40 through the pBTS 8ₖ, in step 200 of FIG. 6. If the MS user desires to be provided with the private mobile communication service, the MS user will first input the #-key before inputting the originating number. The call origination message transmitted from the pBTS 8ₖ to the public/private communication service unit 12 has the packet message format shown in FIG. 7. The pBTS 8ₖ records a destination address corresponding to the call manager 50 in the DEST_ADDR field, a source address corresponding to it in the SRC_ADDR field, and the call origination message in the MSG field.

Upon receipt of the call origination message in the packet message format of FIG. 7 from the pBTS 8ₖ, the pCIN 42 in the PBSC′ 40 transmits the received call origination message to the call manager 50 in step 202. More specifically, upon receipt of the packet message shown in FIG. 7, the pCIN 42 examines the TYPE field, and transmits the packet message, i.e., the call origination message to the call manager 50, if the destination address recorded in the DEST_ADDR field corresponds to the call manger 50 and the information recorded in the TYPE field is a control message. The call origination message is applied to the pBTMR 54 through the DCI 52 in the call manager 50. The pBTMR 54 checks the SIG_ID field of the received message, and if it is the signaling information for the origination call, the pBTMR 54 requests in step 204 an analysis to determine whether the originating MS is registered in the pVLR 64 for the private mobile communication service. When the pVLR 64 notifies the analysis results, the pBTMR 54 determines in step 206 whether the originating MS is registered for the private mobile communication service. If the originating MS is registered for the private mobile communication service, the procedure proceeds to step 208 where the pBTMR 54 examines the originating number recorded in the MSG field to determine whether the originating number is a private mobile communication network number. If the originating number is a private mobile communication network number, there will be the #-key information added at the head of the originating number.

If it is determined in step 206 that the originating MS is not registered for the private mobile communication service or if it is determined in step 208 that the originating number is not a private mobile communication network number, the pBTMR 54 performs an operation of step 218. In step 218, the pBTMR 54 recognizes the call origination message as a message for the public mobile communication service, and transmits the call origination message to the public BSC 4ₘ. More specifically, the pBTMR 54 changes the destination address recorded in the DEST_ADDR field in the call origination message to an address of the public BSC 4ₘ, and transmits the call origination message to the pCIN 42 through the DCI 52. The pCIN 42 transmits the call origination message to the public BSC 4ₘ according to the destination address recorded in the DEST_ADDR field of the call origination message. The public BSC 4ₘ will transmit the call origination message to the MSC 2₁ and the MSC 2₁ will perform the known public mobile communication service using the call origination message.

If it is determined in step 206 that the originating MS is registered for the private mobile communication service and subsequently, if it is also determined in step 208 that the originating number is the private mobile communication network number, the pBTMR 54 determines to provide the private mobile communication service and proceeds to step 210 where the pBTMR 54 transmits the call origination message to the pBSC 56 in the call manager 50. In step 212, the pBSC 56 allocates a vocoder resource of the TSB 44 and transmits the call origination message to the pMSC 58. Upon receipt of the call origination message, the pMSC 58 records in the pVLR 64 the fact that there is a private mobile communication network call from the originating MS, controls the switch 32 in the PBX 30 and transmits a termination ring message to the MS corresponding to the originating number, in step 214. Thereafter, in step 216, the pMSC 58 sets up a call when the terminating MS responds to the termination ring message. The operations of the pMSC 58 and the pBSC 56 in steps 212 to 216 are introduced for a better understanding of the present invention. Therefore, it is to be noted that the common processing operations of the pMSC 58 and the pBSC 56 during the process of the origination call are similar to the operations performed by the MSC and the BSC in the public mobile communication system.

As described above, the present invention provides a call originating service in a system which provides both the public and private mobile communication services.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A call originating service method in a public/private common mobile communication system, comprising the steps of:
determining whether the call origination message is for the public mobile communication service or the private mobile communication service upon receipt of an origination call message from a mobile station (MS) through a BTS (Base station Transceiver Subsystem) which provides both public and private mobile communication services; and
transmitting the call origination message to either a public mobile communication network or a private mobile communication network based on the determination results.

2. The call originating service method as claimed in claim 1, wherein the determination step comprises the steps of:
determining whether the mobile station is registered for the private mobile communication service; and
determining whether the mobile station is part of the private mobile communication network.

3. A call originating service method in a mobile communication system, the method comprising the steps of:
providing a communication service apparatus which performs public and private mobile communication services with a private BTS (Base station Transceiver Subsystem) connected to at least one of a plurality of base station controllers (BSCs) belonging to a public mobile communication system, each of said plurality of BSCs connected to corresponding ones of a plurality of Mobile Switching Centers (MSC's);
determining in the communication service apparatus whether the call origination message is for the public mobile communication service or the private mobile communication service upon receipt of a call origination message transmitted from the mobile station through the private BTS,;
and
transmitting the call origination message to either a BSC connected to the private BTS or a private BSC for the private mobile communication service according to the determination results.

4. The call originating service method as claimed in claim 3, wherein the determination step comprises the steps of determining
whether the mobile station is registered for the private mobile communication service; and
determining whether said mobile station is part of said private mobile communication network.

5. A mobile communication system, comprising:
a private (Base station Transceiver Subsystem)BTS connected to one a plurality of (Base Station Controllers) BSCs belonging to a public mobile communication system, said public communication system comprising a plurality of (mobile switching centers) MSC's, each one of said MCS's connected to a corresponding one of a plurality of BSC's; and
a router apparatus for, upon receipt of a call origination message transmitted from the mobile station through the private BTS, determining whether the call origination message is for the public mobile communication service or the private mobile communication service, and transmitting the call origination message to either a BSC connected to the private BTS or a private BSC for the private mobile communication service according to the determination results.

6. The mobile communication system of claim 5, wherein said router apparatus comprises a call manager that determines whether a call originating from a mobile station is destined to be handled by a public mobile communication system or a private mobile communication system.

7. The mobile communication system of claim 6, said call manager comprising:
a data communications interface for controlling the interface to the call manager;
a private base station controller;
a private visitor location register;
a private base station transceiver subsystem message router for requesting the private visitor location register whether a mobile station is registered in the private mobile communication service and transmits a call message to said private base station controller; and
a private mobile switching center for recording on the private visitor location register the existence of the transmitting call and forms a telephone line if the mobile station responds.

8. The method of claim 2, wherein said step of determining whether the mobile station is registered for the private mobile communication service comprises the step of consulting a visitor location register (VLR) of a call manager inside a public/private common cell area.

9. The method of claim 2, wherein said step of determining whether the mobile station is registered for the private mobile communication service comprises consulting a visitor location register (VLR) of a call manager inside a public/private common cell area.

10. The method of claim 4, wherein said step of determining whether the mobile station is registered for the private mobile communication service comprises the step of consulting a visitor location register (VLR) of a call manager inside a public/private common cell area.

11. The method of claim 4, wherein said step of determining whether the mobile station is registered for the private mobile communication service comprises consulting a visitor location register (VLR) of a call manager inside a public/private common cell area.

12. The method of claim 2, wherein said call is transmitted to a public communications network if either the mobile station is not registered for private mobile communication service or the transmitting number is not a private mobile communications network number.

13. The method of claim 4, wherein said call is transmitted to a public communications network if either the mobile station is not registered for private mobile communication service or the transmitting number is not a private mobile communications network number.

14. The method of claim 2, wherein said call is handled by said private communications network only if both said mobile station is registered with said private mobile communication service and said transmitting number is a private mobile communication network number.

15. The method of claim 4, wherein said call is handled by said private communications network only if both said mobile station is registered with said private mobile communication service and said transmitting number is a private mobile communication network number.
